(19) United States
(12) Patent Application Publication
(10) Pub. No.: US 2014/0278432 A1
(43) Pub. Date: Sep. 18, 2014

(54) Method And Apparatus For Providing Silent Speech

(71) Applicant: Dale D. Harman, Freehold, NJ (US)

(72) Inventor: Dale D. Harman, Freehold, NJ (US)

(21) Appl. No.: 13/804,131

(22) Filed: Mar. 14, 2013

(51) Int. Cl. G10L 13/04

(52) U.S. Cl. CPC G10L 13/043
USPC 704/261

(57) ABSTRACT

Various embodiments provide a method and apparatus for providing a silent speech solution which allows the user to speak over an electronic media such as a cell phone without making any noise. In particular, measuring the shape of the vocal tract allows creation of synthesized speech without requiring noise produced by the vocal chords.

### TECHNICAL FIELD

The invention relates generally to methods and apparatus for providing silent speech.

### BACKGROUND

This section introduces aspects that may be helpful in facilitating a better understanding of the inventions. Accordingly, the statements of this section are to be read in this light and are not to be understood as admissions about what is in the prior art or what is not in the prior art.

In some known silent speech proposals, the use of conventional speech recognition techniques is suggested. Conventional speech recognition requires training and a database of patterns.

### SUMMARY OF ILLUSTRATIVE EMBODIMENTS

Some simplifications may be made in the following summary, which is intended to highlight and introduce some aspects of the various exemplary embodiments, but such simplifications are not intended to limit the scope of the inventions. Detailed descriptions of a preferred exemplary embodiment adequate to allow those of ordinary skill in the art to make and use the inventive concepts will follow in later sections

Various embodiments provide a method and apparatus for providing a silent speech solution which allows the user to speak over an electronic media such as a cell phone without making any noise. In particular, measuring the shape of the vocal tract allows creation of synthesized speech without requiring noise produced by the vocal chords.

In a first embodiment, an apparatus is provided for providing silent speech. The apparatus includes a data storage and a processor communicatively connected to the data storage. The processor is programmed to: output an output signal; receive an impulse response associated with the output signal; determine a vocal tract impedance profile based on the impulse response; create a speech signal based on the vocal tract impedance profile; and output the speech signal.

In a second embodiment, a system is provided for providing silent speech. The system includes: a silent speech controller; a pulse output communicatively connected to the silent speech controller; a response input communicatively connected to the silent speech controller; and a target device communicatively connected to the silent speech controller. Where the silent speech controller is configured to: output an output signal to the pulse output; receive an impulse response associated with the output signal from the response input; determine a vocal tract impedance profile based on the impulse response; create a speech signal based on the vocal tract impedance profile; and output the speech signal to the target device. Where the target device is configured to: output an audio signal based on the speech signal.

In a third embodiment, a method is provided for providing silent speech. The method includes: outputting an output signal; receiving an impulse response associated with the output signal; determining a vocal tract impedance profile based on the impulse response; creating a speech signal based on the vocal tract impedance profile; and outputting the speech signal.

In some of the above embodiments, the apparatus further includes an I/O interface. The I/O interface is configured to: output the output signal; receive the impulse response; and output the speech signal.

In some of the above embodiments, the apparatus further includes a pulse output a response input and an I/O interface. The pulse output being configured to output the output signal. The response input being configured to receive the impulse response. The I/O interface being configured to output the speech signal.

In some of the above embodiments, the output signal is one or more acoustic pulses.

In some of the above embodiments, the output signal is between 16-24 kHz.

In some of the above embodiments, the creation of the speech signal includes programming the processor to compare the vocal tract impedance profile with one or more vocal tract impedance profile templates.

In some of the above embodiments, the creation of the speech signal includes programming the processor to: configure the speech signal in a format suitable for a target device. In some of these embodiments, the format is a packetized audio format.

In some of the above embodiments, the speech signal includes an audio signal configured for a headphone and a packetized audio signal configured for wireless transmission to a target device.

In some of the above embodiments, the determination of the vocal tract impedance profile includes programming the processor to: convert the reflected impulse response to the speech signal based on layer peeling.

In some of the above embodiments, determining the vocal tract impedance profile includes: converting the reflected impulse response to the speech signal based on layer peeling.

In a fourth embodiment, a computer-readable storage medium is provided for storing instructions which, when executed by a computer, cause the computer to perform a method. The method includes: outputting an output signal; receiving an impulse response associated with the output signal; determining a vocal tract impedance profile based on the impulse response; creating a speech signal based on the vocal tract impedance profile; and outputting the speech signal.

### BRIEF DESCRIPTION OF THE DRAWINGS

Various embodiments are illustrated in the accompanying drawings, in which:

FIG. 1 illustrates an embodiment of a silent speech system 100 for providing silent speech for exemplary user 190;

FIG. 2 depicts a flow chart illustrating an embodiment of a method 200 for a silent speech controller (e.g., silent speech controller 130 of FIG. 1) to provide silent speech;

FIG. 3 illustrates an embodiment for determining a vocal tract impedance profile using layer peeling; and

FIG. 4 schematically illustrates an embodiment of silent speech controller 130 of FIG. 1.

To facilitate understanding, identical reference numerals have been used to designate elements having substantially the same or similar structure or substantially the same or similar function.

### DETAILED DESCRIPTION OF ILLUSTRATIVE EMBODIMENTS

The description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, the various embodiments described herein are not necessarily mutually exclusive, as some embodiments may be combined with one or more other embodiments to form new embodiments.

As used herein, the term, “or” refers to a non-exclusive or, unless otherwise indicated (e.g., “or else” or “or in the alternative”). Furthermore, as used herein, words used to describe a relationship between elements should be broadly construed to include a direct relationship or the presence of intervening elements unless otherwise indicated. For example, when an element is referred to as being “connected” or “coupled” to another element, the element may be directly connected or coupled to the other element or intervening elements may be present. In contrast, when an element is referred to as being “directly connected” or “directly coupled” to another element, there are no intervening elements present. Similarly, words such as “between”, “adjacent”, and the like should be interpreted in a like fashion.

Various embodiments provide a method and apparatus for providing a silent speech solution which allows the user to speak over an electronic media such as a cell phone without making any noise. In particular, measuring the shape of the vocal tract allows creation of synthesized speech without requiring noise produced by the vocal chords, the delay may be reduced allowing for the ability to converse using silent speech.

Advantageously, by utilizing vocal tract measurements to create a model for the vocal tract which is used to synthesized speech, there may be a reduced delay as compared to proposed systems which use pattern recognition. Reduced delays allow for feedback which may have significant benefits to the accuracy of the articulation and the fluency of the speech conversation as well as being useful as feedback to help improve the speaker's articulation and to reduce interrupts to the flow of a conversation. Furthermore, as compared to pattern matching systems, utilizing vocal tract measurements may require no training or reduced training/retraining during initiation and when using higher frequency sounding impulses.

FIG. 1 illustrates an embodiment of a silent speech system 100 for providing silent speech between exemplary user 190 and an optional target device 150. The silent speech system 100 includes a signal output 110, a response input 120, a silent speech controller 130, and optionally a synthesized output 140.

The signal output 110 includes any suitable device that outputs a suitable signal that is capable of being correlated in the response input 120 to calculate the impulse response. A suitable signal may include, for example, one or more sound pulses or an identified sound sequence.

The response input 120 includes any suitable device capable of receiving the reflected impulse response of at least a portion of the signal outputted by signal output 110. In particular, when user 190 positions signal output 110 as illustrated, response input 120 receives the reflective impulse response of user 190's vocal tract. It should be appreciated that each change in shape of user 190's vocal tract represents a change in the acoustic impedance of the vocal tract which appears as a change in the reflected impulse response received by response input 120.

The speech controller 130 includes any suitable device that is capable of converting the received reflective impulse response into synthesized speech.

The synthesized output 140 includes any suitable device that is capable of converting the synthesized speech into an audio signal. In some embodiments, the synthesized output 140 is a speaker. In some of these embodiments, the speaker is an earphone.

Target device 150 may include any type of communication device(s) capable of sending or receiving information over link 155. For example, a communication device may be a thin client, a smart phone (e.g., target device 150), a personal or laptop computer, server, network device, tablet, television set-top box, conferencing system, media player or the like. Communication devices may rely on other resources within the exemplary system to perform a portion of tasks, such as processing or storage, or may be capable of independently performing tasks. It should be appreciated that while one target device is illustrated here, system 100 may include more clients. Moreover, the number of clients at any one time may be dynamic as clients may be added or subtracted from the system at various times during operation.

Optional link 155 supports communicating over one or more communication channels such as: wireless communications (e.g., LTE, GSM, CDMA, Bluetooth); WLAN communications (e.g., WiFi); packet network communications (e.g., IP); broadband communications (e.g., DOCSIS and DSL); and the like. It should be appreciated that though depicted as a single connection, communication channel 155 may be any number or combinations of communication channels.

In some embodiments, signal output 110 is an acoustic pulse reflectometer. In some of these embodiments, the acoustic pulse reflectometer is an acoustic time domain reflectometer.

In some embodiments, signal output 110 is a time domain reflectometer.

In some embodiments, response input 120 is a microphone which measures the output signal as the sound passes over the microphone's diaphragm.

In some embodiments, synthesized output 140 includes a speaker to provide feedback to user 190. Advantageously, by providing feedback to user 190, user 190 will hear the synthesized sound being created by the shape of their vocal tract and user 190 may adjust their vocal tract closer to the proper shape in response.

In some embodiments, synthesized output 140 includes a speaker to provide audio to a second user. In some of these embodiments, the speaker is in a telephony device being operated by the second user.

In some embodiments, signal output 110, response input 120 or synthesized output 140 are in the same apparatus as silent speech controller 130.

In some embodiments, silent speech controller 130 includes suitable I/O interfaces for interfacing with signal output 110, response input 120, synthesized output 140, or link 155.

It should be appreciated that though depicted as single connections, connections between silent speech controller and signal output 110, response input 120, synthesized output 140, or target device 150 may include any suitable type and number of connections.

In some embodiments, silent speech controller 130 is within a communication device such as a smart phone. In some of these embodiments, signal output 110, response input 120 or synthesized output 140 are also within the same communication device.

In some embodiments, silent speech controller 130 is within a recording device such as a voice recorder. In some of these embodiments, silent speech controller 130 does not include an I/O interface to link 155.

FIG. 2 depicts a flow chart illustrating an embodiment of a method 200 for a silent speech controller (e.g., silent speech controller 130 of FIG. 1) to provide silent speech. The method includes: outputting an output signal (step 220); receiving the reflected impulse response associated with the output signal (step 230); determining a vocal tract impedance profile from the received reflected impulse response (step 240); creating a speech signal based on the determined vocal tract impedance profile (step 250); and outputting the speech signal (step 260).

In the method 200, the step 220 includes outputting an output signal to a signal output device such as signal output 110 of FIG. 1. In some embodiments, the output signal represents an acoustic pulse.

In the method 200, the step 230 includes receiving the reflected impulse response associated with the output signal from a response input (e.g., response input 120 of FIG. 1).

In the method 200, the step 240 includes determining a vocal tract impedance profile from the received reflected impulse response. In particular, the reflected impulse response is converted into the impedance changes of the vocal tract by layer peeling. Each impedance change in the vocal tract is peeled out of the reflected impulse response yielding the impedance profile of the vocal tract.

It should be appreciated that the reflected impulse response contains associated reflections in the output signal caused by characteristics of the user's vocal tract. For example, when the output signal (e.g., an output pulse) encounters a discontinuity in the vocal tract's cross section, a reflection is created. The amplitude and form of the reflection is determined by the characteristics of the discontinuity: a constriction may create a positive reflection, whereas a dilation (increase in cross section) may create a negative reflection. Neither of these discontinuities will change the shape of the pulse in their vicinity, but the reflection measured by the response input (e.g., response input 120) will be an attenuated and smeared replica of the impinging pulse, due to propagation losses.

In the method 200, the step 250 includes creating a speech signal based on the determined vocal tract impedance profile. In particular, the frequency response of the vocal tract is determined based on the impedance profile and the speech signal (e.g., speech sound or synthesized speech) is based on the determined frequency response.

In the method 200, the step 260 includes outputting the speech signal (e.g., to synthesized output 140 or target device 150 of FIG. 1).

In some embodiments of the step 210 or 220, the output signal is a range within the ultrasonic band just above the hearing threshold. In some of these embodiments, the range is 16-24 kHz. In some of these embodiments, the range is 20-28 kHz.

In some embodiments of the step 210 or 220, the output signal is an acoustic pulse.

In some embodiments of the step 250, the creation of the speech signal includes creating the speech signal in a format suitable for a target device (e.g., target device 150 of FIG. 1). A suitable format may include any suitable format such as: analog audio, packetized audio such as VoIP, CDMA or the like.

In some embodiments of step 250, the speech signal is determined based on a comparison of the determined vocal tract impedance profile with stored vocal tract impedance profile templates that represent speech sounds.

In some embodiments of the steps 240 or 250, layer peeling for an impulse input is accomplished by modeling the vocal tract as a Kelly Lochbaum ladder such as illustrated in FIG. 3. In the illustrated ladder, the length of each vocal tract section is based on the delay or sampling rate and the speed of sound. In the ladder, each stage k1-k5 represents one section of the vocal tract and the reflection coefficient kₙ is related to the area of the vocal tract before and after each respective section (n−1) and n. The reflection coefficients, k₁-k₄, may be determined using layer peeling as shown in equations [Eq. 1]-[Eq. 5] below (e.g., reflection coefficients kn are derived from successive values of Rₙ and inₙ). Where output signal 310 is an impulse in and reflection values R₁-R₄ represent impulse response 320 as given in equations [Eq. 6]-[Eq. 9]. It should be appreciated that while five stages are illustrated here, system 300 may include more or less stages. It should be further appreciated that equations [Eq. 1]-[Eq. 9] are just one exemplary mathematical formulation of the transformation of a vocal tract and any suitable formulation may be used.

inₙ=1 for n=1; else inₙ=0 [Eq.1]

k₁=(R₁)/(in₁) [Eq. 2]

k₂=(R₂−k₁*in₂)/((1−k₁²)*in₁) [Eq. 3]

k₃=(R₃−(1−k₁²)*k₂²*(−k₁)*in₁)/((1−k₁²)*(1−k₂²)) [Eq. 4]

k₄=(R₄−(1−k₁²)*(1−k₂²)*k₃²*(−k₂)*in₁−(1−k₁²)*k₂²*k₁²*(−k₂)*in₁*((1−k₁²)*(1−k₂²)*(1−k₃²)*in₁) [Eq. 5]

R₁=k₁*in₁ [Eq. 6]

R₂=k₁*in₂+k₂*(1−k₁²)*in₁ [Eq. 7]

R₃=k₁*in₃+k₂*(1−k₁²)*in₂+(1−k₁²)*k₂²*(−k₁)*in₁+(1−k₁²)*(1−k₂²)*k₃*in₁ [Eq. 8]

R₄=k₁*in₄+k₂*(1−k₁²)in₃+(1−k₁²)*k₂²*(−k₁)*in₃+(1−k₁²)*(1−k₂²)*k₃*in₃+(1−k₁²)*(1−k₂²)*k₃²*(−k₂)*in₁+(1−k₁²)*k₂²*k₁²*(−k₂)*in₁+(1−k₁²)*(1−k₂²)*(1−k₃²)*k₄*in₁+2*(1−k₁²)*k₂*(−k₁²)*(1−k₂²)*k₃*in₁ [Eq. 9]

From the determination of the reflection coefficients, k₁-k₄, impedance changes between the slices of the vocal tract and the frequency response of the vocal tract may be determined. Impedance changes are related to the area changes between slices of the vocal tract. The determined impedance changes and frequency responses are used to create the speech signal (e.g., the synthesized speech).

Although primarily depicted and described in a particular sequence, it should be appreciated that the steps shown in method 200 may be performed in any suitable sequence. Moreover, the steps identified by one step may also be performed in one or more other steps in the sequence or common actions of more than one step may be performed only once.

It should be appreciated that steps of various above-described methods can be performed by programmed computers. Herein, some embodiments are also intended to cover program storage devices, e.g., data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable data storage media. The embodiments are also intended to cover computers programmed to perform said steps of the above-described methods.

FIG. 4 schematically illustrates an embodiment of silent speech controller 130 of FIG. 1. The apparatus 400 includes a processor 410, a data storage 411, and optionally an I/O interface 430.

The processor 410 controls the operation of the apparatus 300. The processor 410 cooperates with the data storage 411.

The data storage 411 stores programs 420 executable by the processor 410. Data storage 411 may also optionally store program data such as trained impedance profiles, or the like as appropriate.

The processor-executable programs 420 may include an I/O interface program 421, a vocal track impedance profile (VTIP) program 423, or a speech synthesis program 425. Processor 410 cooperates with processor-executable programs 420.

The I/O interface 430 cooperates with processor 410 and I/O interface program 421 to support communications between the apparatus and a pulse output, response input, synthesized output, or target device (e.g., over link 155 or between signal output 110, response input 120, synthesized output 140, or target device 150 of FIG. 1). In particular, the I/O interface program 421 performs the steps of step 220, 230, or 260 of FIG. 2 as described above.

The VTIP program 423 performs the steps of step 240 of FIG. 2 as described above.

The speech synthesis program 425 performs steps or step 250 of FIG. 2 as described above.

In some embodiments, the processor 410 may include resources such as processors/CPU cores, the I/O interface 430 may include any suitable network interfaces, or the data storage 411 may include memory or storage devices. Moreover the apparatus 400 may be any suitable physical hardware configuration such as: one or more server(s), blades consisting of components such as processor, memory, network interfaces or storage devices. In some of these embodiments, the apparatus 400 may include cloud network resources that are remote from each other.

In some embodiments, the apparatus 400 may be virtual machine. In some of these embodiments, the virtual machine may include components from different machines or be geographically dispersed. For example, the data storage 411 and the processor 410 may be in two different physical machines.

In some embodiments, the apparatus 400 may be a smart phone.

When processor-executable programs 420 are implemented on a processor 410, the program code segments combine with the processor to provide a unique device that operates analogously to specific logic circuits.

Although depicted and described herein with respect to embodiments in which, for example, programs and logic are stored within the data storage and the memory is communicatively connected to the processor, it should be appreciated that such information may be stored in any other suitable manner (e.g., using any suitable number of memories, storages or databases); using any suitable arrangement of memories, storages or databases communicatively connected to any suitable arrangement of devices; storing information in any suitable combination of memory(s), storage(s) or internal or external database(s); or using any suitable number of accessible external memories, storages or databases. As such, the term data storage referred to herein is meant to encompass all suitable combinations of memory(s), storage(s), and database(s).

The description and drawings merely illustrate the principles of the invention. It will thus be appreciated that those skilled in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

The functions of the various elements shown in the FIGs., including any functional blocks labeled as “processors”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional or custom, may also be included. Similarly, any switches shown in the FIGS. are conceptual only. Their function may be carried out through the operation of program logic, through dedicated logic, through the interaction of program control and dedicated logic, or even manually, the particular technique being selectable by the implementer as more specifically understood from the context.

It should be appreciated that any block diagrams herein represent conceptual views of illustrative circuitry embodying the principles of the invention. Similarly, it should be appreciated that any flow charts, flow diagrams, state transition diagrams, pseudo code, and the like represent various processes which may be substantially represented in computer readable medium and so executed by a computer or processor, whether or not such computer or processor is explicitly shown.

What is claimed is:

1. An apparatus for providing silent speech, the apparatus comprising:
a data storage; and
a processor communicatively connected to the data storage, the processor being configured to:
output an output signal;
receive an impulse response associated with the output signal;
determine a vocal tract impedance profile based on the impulse response;
create a speech signal based on the vocal tract impedance profile; and
output the speech signal.

2. The apparatus of claim 1, wherein the apparatus further comprises:
an I/O interface, the I/O interface configured to:
output the output signal;
receive the impulse response; and
output the speech signal.

3. The apparatus of claim 1, wherein the apparatus further comprises:
a pulse output, the pulse output configured to:
output the output signal;
a response input, the response input configured to:
receive the impulse response; and
an I/O interface, the I/O interface configured to:
output the speech signal.

4. The apparatus of claim 1, wherein the output signal is one or more acoustic pulses.

5. The apparatus of claim 4, wherein the output signal is between 16-24 kHz.

6. The apparatus of claim 1, wherein the creation of the speech signal comprises configuring the processor to:
compare the vocal tract impedance profile with one or more vocal tract impedance profile templates.

7. The apparatus of claim 1, wherein the creation of the speech signal comprises configuring the processor to:
configure the speech signal in a format suitable for a target device;
wherein the format is a packetized audio format.

8. The apparatus of claim 1, wherein the speech signal comprises an audio signal configured for a headphone and a packetized audio signal configured for wireless transmission to a target device.

9. The apparatus of claim 1, wherein the determination of the vocal tract impedance profile comprises configuring the processor to:
convert the reflected impulse response to the speech signal based on layer peeling.

10. A system for providing silent speech, the system comprising:
a silent speech controller;
a pulse output communicatively connected to the silent speech controller;
a response input communicatively connected to the silent speech controller; and
a target device communicatively connected to the silent speech controller;
wherein the silent speech controller is configured to:
output an output signal to the pulse output;
receive an impulse response associated with the output signal from the response input;
determine a vocal tract impedance profile based on the impulse response;
create a speech signal based on the vocal tract impedance profile; and
output the speech signal to the target device; and
the target device is configured to:
output an audio signal based on the speech signal.

11. A method for providing silent speech, the method comprising:
at a processor communicatively connected to a data storage, outputting an output signal;
receiving, by the processor in cooperation with the data storage, an impulse response associated with the output signal;
determining, by the processor in cooperation with the data storage, a vocal tract impedance profile based on the impulse response;
creating, by the processor in cooperation with the data storage, a speech signal based on the vocal tract impedance profile; and
outputting, by the processor in cooperation with the data storage, the speech signal.

12. The method of claim 11, wherein the output signal is one or more acoustic pulses.

13. The method of claim 11, wherein the output signal is between 16-24 kHz.

14. The method of claim 11, wherein the step of creating the speech signal comprises:
comparing, by the processor in cooperation with the data storage, the vocal tract impedance profile with one or more vocal tract impedance profile templates.

15. The method of claim 11, wherein the step of creating the speech signal comprises:
configuring, by the processor in cooperation with the data storage, the speech signal in a format suitable for a target device;
wherein the format is a packetized audio format.

16. The method of claim 11, wherein the speech signal comprises an audio signal configured for a headphone and a packetized audio signal configured for wireless transmission to a target device.

17. The method of claim 11, wherein the step of determining the vocal tract impedance profile comprises:
converting, by the processor in cooperation with the data storage, the reflected impulse response to the speech signal based on layer peeling.

18. A computer-readable storage medium storing instructions which, when executed by a computer, cause the computer to perform a method, the method comprising:
outputting an output signal;
receiving an impulse response associated with the output signal;
determining a vocal tract impedance profile based on the impulse response;
creating a speech signal based on the vocal tract impedance profile; and
outputting the speech signal.
